(19) United States
(12) Patent Application Publication
(10) Pub. No.: US 2002/0030580 A1
(43) Pub. Date: Mar. 14, 2002

(54) Writing apparatus

(76) Inventor: Gerald Prudholme, Diamond Bar, CA (US)

Correspondence Address: Matthew J. Peirce, Esq., 1550 Strarlight Canyon Avenue, Las Vegas, NV, 89123, US

(21) Appl. No.: 09/949,174

(22) Filed: Sep. 7, 2001

Related U.S. Application Data
(60) Provisional application No. 60/231,239, filed on Sep. 8, 2000.

(51) Int. Cl. G05B 19/00

(52) U.S. Cl. 340/5.31

(57) ABSTRACT

The present invention concerns that of a new and improved apparatus which would assist a police automobile or other properly designated vehicle in ensuring that a chased vehicle would actually stop and pull over. The apparatus would comprise of two units, a main unit and a remote control transmitter. The main unit would be attached to all vehicles, while the transmitter unit would be attached to a police automobile or other properly designated vehicle. The main unit would comprise a ball shut-off valve, an electric motor, a circuit board, and power means. The transmitter would include a keyboard and pair of indicator lights.

### I. BACKGROUND OF THE INVENTION

The present invention concerns that of a new and improved apparatus which would assist a police automobile or other properly designated vehicle in ensuring that a chased vehicle would actually stop and pull over.

### II. DESCRIPTION OF THE PRIOR ART

U.S. Pat. No. 5,861,799, issued to Szwed, discloses an invention which relates to a device and system for preventing improper use of a car.

U.S. Pat. No. 5,506,562, issued to Wiesner, discloses a device for shutting off an engine remotely and sounding off an alarm locally.

U.S. Pat. No. 4,660,528, issued to Buck, discloses an invention which is directed to RF means for terminating the normal operations of a selected motor vehicle.

### III. SUMMARY OF THE INVENTION

The present invention concerns that of a new and improved apparatus which would assist a police automobile or other properly designated vehicle in ensuring that a chased vehicle would actually stop and pull over. The apparatus would comprise of two units, a main unit and a remote control transmitter. The main unit would be attached to all vehicles, while the transmitter unit would be attached to a police automobile or other properly designated vehicle. The main unit would comprise a ball shut-off valve, an electric motor, a circuit board, and power means. The transmitter would include a keyboard and pair of indicator lights.

There has thus been outlined, rather broadly, the more important features of a public safety apparatus in order that the detailed description thereof that follows may be better understood and in order that the present contribution to the art may be better appreciated. There are, of course, additional features of the public safety apparatus that will be described hereinafter and which will form the subject matter of the claims appended hereto.

In this respect, before explaining at least one embodiment of the public safety apparatus in detail, it is to be understood that the public safety apparatus is not limited in its application to the details of construction and to the arrangements of the components set forth in the following description or illustrated in the drawings. The public safety apparatus is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present public safety apparatus. It is important, therefore, that the claims be regard as including such equivalent constructions insofar as they do not depart from the spirit and scope of the present invention.

It is therefore an object of the present invention to provide a public safety apparatus which has all of the advantages of the prior art and none of the disadvantages.

It is another object of the present invention to provide a public safety apparatus which may be easily and efficiently manufactured and marketed.

It is another object of the present invention to provide a public safety apparatus which is of durable and reliable construction.

It is yet another object of the present invention to provide a public safety apparatus which is economically affordable and available to the buying public.

It is yet another object of the present invention to provide a public safety apparatus which provides additional benefits not present in the prior art.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a side view of the main unit of the present invention.

FIG. 2 shows a front view of the transmitter of the present invention.

### V. DESCRIPTION OF THE PREFERRED EMBODIMENT

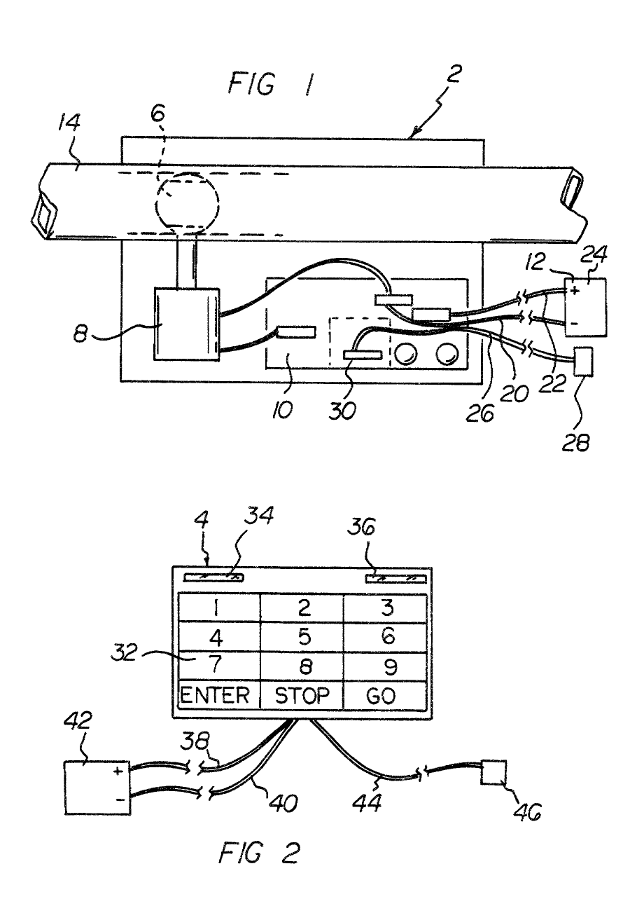

FIG. 1 shows a side view of the main unit 2 of the present invention. The present invention concerns that of a new and improved apparatus which would assist a police automobile or other properly designated vehicle in ensuring that a chased vehicle would actually stop and pull over. The apparatus would comprise of two units, a main unit 2 and a remote control transmitter 4. The main unit 2 would be attached to all vehicles, while the transmitter 4 would be attached to a police automobile or other properly designated vehicle.

The main unit 2 would comprise a ball shut-off valve 6, an electric motor 8, a circuit board 10, and power means 12. Valve 6 would be within the fuel line 14 of a vehicle and would have two positions, an “on” position” and an “off” position. In normal use of the particular vehicle 16 to which main unit 2 would be attached to, valve 6 would be in the “off” position, allowing normal delivering of fuel through fuel line 14 to the engine 18 of the vehicle 16.

Electric motor 8 would be connected to power means 12 by leads 20 and 22. Power means 12 would preferably be the battery 24 of vehicle 16. Electric motor 8 would also have lead 26 which would attach to antenna 28 of vehicle 16. Electric motor 8 would also have incorporated receiver 30, located on circuit board 10, which would be capable of receiving radio waves from transmitter 4.

When receiver 30 would receive radio waves of a particular wavelength from a transmitter 4, electric motor 8 would activate valve 6 to an “on” position. At this time, fuel in fuel line 14 would be prevented from traveling onward to engine 18 in vehicle 16. At that time, vehicle 16 would cease to operate and would stall, if engine 18 in vehicle 16 had not already been turned off.

FIG. 2 shows a front view of the transmitter 4 of the present invention. The transmitter 4 would include a keyboard 32 and indicator lights 34 and 36. A police officer or other authorized official would be able to type in a specific code on keyboard 32, which would apply to a particular vehicle or vehicles being chased. At that time, transmitter 4 would send out radio waves of the proper frequency to the particular receiver 30 of a vehicle being chased, with the result that valve 6 would turn to the “on” position and prevent fuel in fuel 14 from reaching engine 18 in vehicle 16.

Transmitter 4 would have leads 38 and 40, which would connect to power means 42. Power means 42 would preferably be a car battery. Transmitter 4 would also have antenna lead 44, which would connect to antenna 46 of the vehicle which would include transmitter 4.

What I claim as my invention is:

1. An apparatus for stopping the engine of a vehicle comprising:
(a) a first vehicle, the first vehicle including power means, the first vehicle further including an engine, the first vehicle further including an antenna, the first vehicle further including a fuel tank, the first vehicle further including a fuel line which would be connected to both the engine and the fuel line,
(b) a receiver unit attached to the first vehicle, the receiver unit comprising a ball shut-off valve, the ball shut-off valve having two positions, an “on” position and an “off” position, the receiver unit further including an electric motor which would be connected to the ball shut-off valve, the receiver unit further including a pair of electrical connections connecting the electric motor to the power means within the first vehicle, the receiver unit further including a circuit board, the receiver unit further including a receiver connected to the circuit board, the receiver unit further including a third electrical connection having two ends, a first end and a second, the first end of the third electrical connection connected to the antenna, the second end of the third electrical connection connected to the circuit board,
(c) a second vehicle, the second vehicle comprising a law enforcement vehicle, the second vehicle including power means,
(d) a remote control transmitter located in the second vehicle comprising a transmitter, the remote control transmitter further comprising a keyboard electronically connected to the transmitter, the remote control transmitter further comprising a pair of electrical leads connecting the transmitter to the power means within the second vehicle, the remote control transmitter further comprising an antenna electrically connected to the transmitter, the remote control transmitter further comprising a pair of indicator lights,
(e) whereby a driver in the second vehicle would input a code on the keyboard that would be recognized by the receiver in the first vehicle, whereby the transmitter would then emit radio waves of a specific wavelength that the receiver on the first vehicle would recognize, whereby the receiver unit then would turn activate the electrical motor, whereby the electrical motor would turn the ball shut-off valve to the “on” position and shut the engine within the first vehicle off.

2. An apparatus for stopping the engine of a vehicle according to claim 1 wherein the power means within the first vehicle is an automobile battery.

3. An apparatus for stopping the engine of a vehicle according to claim 1 wherein the power means within the second vehicle is an automobile battery.

4. An apparatus for stopping the engine of a vehicle according to claim 1 wherein the keyboard located on the remote control transmitter would comprise keys numbered one through nine, an “enter” key, a “stop” key, and a “go” key.
